(19) United States
(12) Patent Application Publication
(10) Pub. No.: US 2010/0052555 A1
(43) Pub. Date: Mar. 4, 2010

(54) POWER SUPPLY SYSTEM, LAMP SYSTEM AND METHOD OF CONTROLLING LIGHT INTENSITY

(75) Inventors: Andries Bron, Drachten (NL); Jacob Dijkstra, Drachten (NL); Wilhelmus Ettes, Drachten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/531,096

(22) PCT Filed: Feb. 20, 2008
(86) PCT No.: PCT/IB2008/050605

§ 371 Date: Sep. 14, 2009

(30) Foreign Application Priority Data
Feb. 28, 2007 (EP) 07103186.8

(51) Int. Cl. H05B 37/02; H02J 3/00

(52) U.S. Cl. 315/210; 307/31

(57) ABSTRACT

A plurality of loads (12) such as lamps receives power through respective switches. A control circuit (16) controls the switches (14). The control circuit controls energy supplied to the loads (12) by causing the switches (14) to switch current to loads of a first half of the plurality of loads (12) on or off at one or more selectable phase points (30a,b) during each positive half of the AC cycles. The control circuit switches current to loads of a second half of the plurality of the loads (12) half an AC cycle out of phase with corresponding loads in the first half of the loads (12). In an embodiment there are least four loads (12), and the control circuit switches on lamps in the first half at two phase points (230a,b) with a temporal offset with respect to each other.

### FIELD OF THE INVENTION

The invention relates to a power supply system, to an electrical lamp system with controllable light intensity and a method of controlling light intensity.

### BACKGROUND OF THE INVENTION

It is known to realize control of light intensity of electrical lamps by means of phase angle cutting. With this technique the AC mains supply current to an electrical lamp is periodically cut off and switched on again in phase with the AC cycle of the mains supply. The phase angle where the supply current is cut-off is selected dependent on the desired light intensity.

In the case of high power lamps, such as IR light heating lamps, this technique has the disadvantage that it generates strong harmonics of the AC signal, which can interfere with the operation of other devices connected to the AC mains supply.

One known way of reducing harmonics generated by phase angle cutting is to increase the period with which the AC current cut off is performed to an integer multiple of the AC cycle period. However, for electrical lamps this is not usually acceptable, because such a long period results in human visible intensity flickering of the lamp.

U.S. Pat. No. 6,028,421 describes a lamp system with a two lamps. The different lamps are switched on and off in different basic cycles, wherein a lamp receives current during a half cycle of the AC mains cycle. Thus light intensity is controlled without generation strong harmonics. However, due to flicker, the system is unsuitable for lamps whose light can be viewed individually.

### SUMMARY OF THE INVENTION

Among others, it is an object of the invention to provide for a power supply system with controllable power delivery wherein the generated harmonics are not strong and wherein power variations with a sub-harmonic frequency below the AC cycle frequency are avoided.

Among others, it is an object of the invention to provide for a lamp system with controllable light intensity wherein the generated harmonics are not strong and wherein human visible flicker is minimized.

A power supply system according to claim 1 is provided for. Herein a first half of a plurality of loads such as lamps the load is switched on or off at a selectable phase point in a positive half cycle of each AC cycle and the second half of the loads is switched in the same way, but in a negative half cycle half a cycle later. The selected phase points may be selected dependent on the desired light intensity. Thus harmonics generation is reduced with a minimum of flicker.

In an embodiment the system comprises at least four loads, and there is a temporal offset between the selected phase points where a first and second subset of the first half of the loads are switched on or off. It has been found that this makes it possible to realize the level of harmonics required by interference regulations.

### BRIEF DESCRIPTION OF THE DRAWINGS

These and other objects and advantageous aspects of the invention will become apparent from a description of exemplary embodiments, using the following figures.

FIG. 1 shows a lamp system;

FIG. 2 shows lamp currents in a lamp system;

FIG. 3 shows lamp currents in a further lamp system;

FIG. 3a shows a combined current;

FIG. 4 shows an embodiment of a control circuit.

### DETAILED DESCRIPTION OF EXEMPLARY EMBODIMENTS

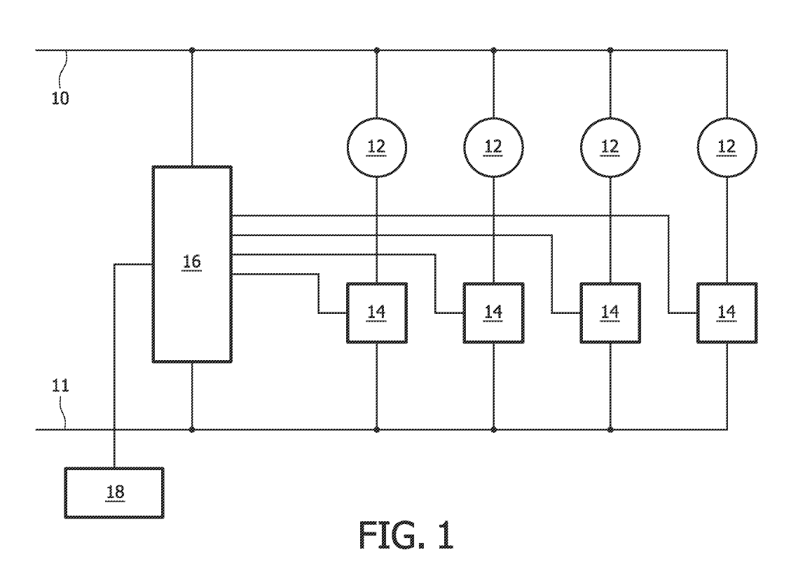

FIG. 1 shows a power supply system. By way of example a lamps system is shown, comprising terminals 10, 11 of an AC power supply connection, lamps 12, switches 14, a control circuit 16 and a power control interface 18. Lamps 12 and switches 14 are arranged in respective series arrangements, each series arrangement comprising a lamp 12 and a switched electrically connected in series between terminals 10, 11 of the AC power supply connection. Power control interface 18 may be power selection switch, a remote control unit etc. Power control interface 18 has an output coupled to control circuit 16. Control circuit 16 may comprise a programmed microcontroller circuit, or a dedicated power control circuit for example. Control circuit 16 has inputs coupled to the terminals 10, 11 of the AC power supply connection and outputs coupled to control inputs of switches 14. Switches 14 may be implemented for example as bidirectional mosfets, triacs etc.

In operation control circuit 16 controls on/off switching of switches 14. Control circuit 16 receives a power setting from control interface 18. Control circuit 16 detects predetermined reference phase points of the AC power supply voltage at terminals 10, 11 of the AC power supply connection. Control circuit 16 controls switches 14 to switch on and off at selected phase points in the AC cycle detected from the reference phase points. Control circuit 16 determines the selected phase points dependent on the power setting from control interface 18.

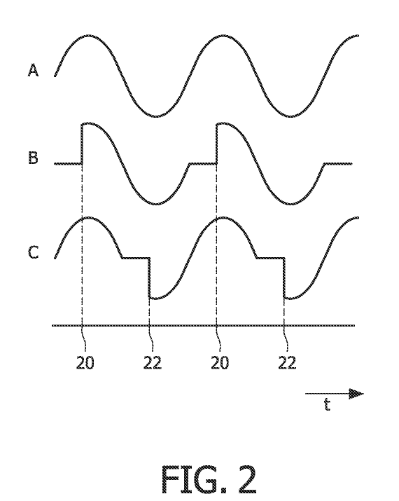

FIG. 2 shows the AC voltage in a first trace and lamp currents of a first and second set of two of the lamps 12 in a second and third trace B,C respectively. As can be seen current to lamps 12 in the first set is cut off at the start of each positive current half cycle of the AC mains cycle and switched back on at a selected phase point 20 during the positive current half cycle of the AC mains cycle. In contrast, current to lamps 12 in the second set is cut off at the start of each negative current half cycle of the AC mains cycle and switched back on at a selected phase point 22 during the negative current half cycle of the AC mains cycle.

Control circuit 16 makes the selected phase points 20, 22 during the positive negative current half cycle of the AC mains cycle equal to each other. The lamps have equal resistance. Thus no net DC current flows from mains terminals 10, 11. Because only part of the lamps are switched on during each half cycle the strength of harmonics is reduced compared to the case wherein all lamps would be switched on at the same time. Because all lamps are switched on and off in each AC mains cycle, no visible flicker can be observed. As may be noted this method of switching can be applied to any even number of lamps, for example two lamps instead of the four of the system of FIG. 1.

It has been found that at least the maximum values within the current limits that are possible in a standard normal household mains group (16 Ampere) current switching as shown in FIG. 2 can still generate unacceptably strong harmonics. For example, in a 3000 Watt lamp system, it has been found that the odd ninth to fifteenth harmonics may exceed maximum imposed by regulatory bodies e.g. in the IEC 61000-3-2 regulation.

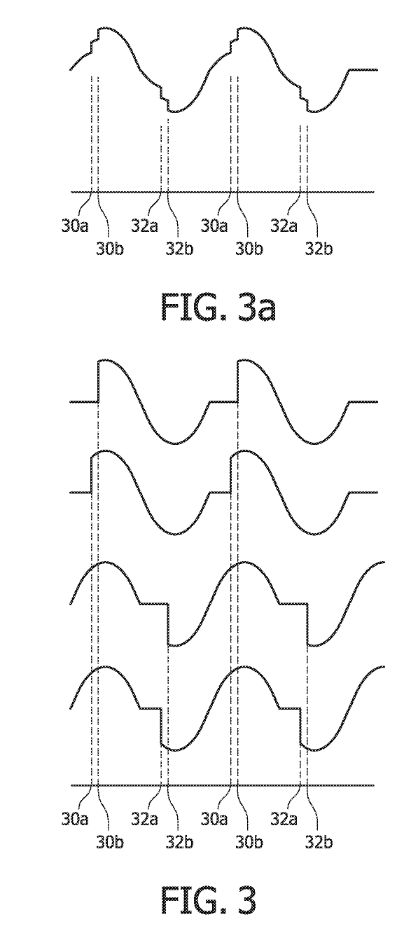

FIG. 3 shows improved lamp currents for four lamps. As in FIG. 2 a first and second set of lamps are used, current to the lamps in the first and second set being kept off during time intervals of each positive and negative half cycle of the AC mains cycle respectively. However, the time intervals of FIG. 3 are distinguished from those of FIG. 2 because the phase points 30a,b, 32a,b where the lamps of the same set are switched on are offset relative to one another. It has been found that by selecting the size of the offset, the strength of the harmonics can be controlled. This makes it possible to reduce the strength of the harmonics to acceptable levels. It has been found that this suffices to realize levels below levels imposed by the IEC 61000-3-2 regulation. FIG. 3a shows the resulting total current, the sum of the currents through the different loads.

This form of power control is especially useful for example for solaria with IR (Infrared) lamps. The high intensity of such lamps can be unpleasant for certain users, making it desirable to control the intensity. At the same time perceptible differences between the intensity from different lamps and visible flicker of the lamps should be avoided. This can be achieved with the illustrated lamp system.

It should be noted that the phase points can be placed anywhere in the AC cycle. FIG. 3 shows an example where the phase points are near 90 degree phase, but this is only an example other phase points may be used. When triacs are used as switches, the switch off of each switch should occur near zero current through the switch, as shown. When other type of switches are used the switch off may occur at any phase, and an offset may be used between the switch-off of different switches.

Control circuit 16 may be implemented using a programmed microcontroller. In an embodiment this microcontroller is provided with one or more timers, and a zero crossing detector. The zero crossing detector detects zero crossings at the mains input at terminals 10, 11 and signals them to the microcontroller. In response the microcontroller executes a program part to switch off the switches 14 to a first half of the lamps 12 and starts a timer or timers to count a selected time interval from the zero crossing to a first selected phase point or a first and second selected phase point. The time interval is selected dependent on the desired power level; alternatively, the microcontroller may execute a number of instructions, the number of instructions being selected dependent on the desired power level.

When the timer signals that the first phase point has been reached the microcontroller executes a program part to switch on the switches 14 to the first of half the lamps 12 in the case of the embodiment shown in FIGS. 2a,b, or to half of the first half in the embodiment shown in FIG. 3. In the embodiment of FIG. 3 the microcontroller next executes instruction to count off the offset, or starts the timer again to count of the offset, or waits for a signal from the second timer, before switching back on the current to the remainder of the first of half the lamps 12. After a next zero crossing (to an opposite polarity half cycle) the microcontroller dose the same for a second half of the lamps.

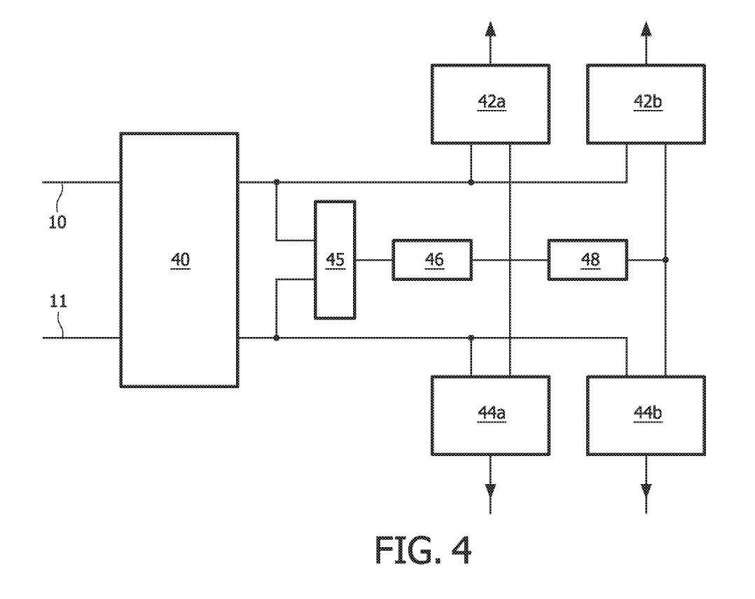

FIG. 4 shows an embodiment of a dedicated control circuit for controlling the lamps. The circuit comprises a zero crossings detector 40, first and second control registers 42a,b, 44a,b, an OR gate 45 and a first and second delay circuits 46, 48. Zero crossings detector 40 has inputs coupled to the terminals 10, 11 of the AC mains supply and first and second outputs for signaling zero crossings of the AC voltage in respective directions. The first output of zero crossings detector 40 is coupled to reset inputs of first control registers 42a,b. The second output is coupled to reset inputs of second control registers 44a,b. The first and second output are coupled to inputs of OR gate 45, which has an output coupled to an input of the first delay circuit 46 (the OR gate is shown by way of illustration; as an alternative zero crossings detector 40 may have an output for signaling crossings in any direction).

First delay circuit has a delay control input coupled to the power control interface 18 (not shown). An output of the first delay circuit 46 is coupled to an input of the second delay circuit 48. The output of the delay circuit 46 is coupled to a set input of one of the first control registers 42a and one of the second control registers 44a. The output of the second delay circuit 46 is coupled to a set input of the other one of the first control registers 42b and the other one of the second control registers 44b. The control registers 42a,b, 44a,b have outputs coupled to respective ones of the switches 14 (not shown).

In operation the control registers 42a,b, 44a,b, when set, cause the switches (not shown) to allow current to flow through the lamps (not shown). When zero crossings detector 40 detects a zero crossing in one direction it resets first control registers 42a,b reset to interrupt AC current supply to half the lamps. After a delay determined by first delay circuit 46 a first one of first control registers 42a is set to restore current to one of the lamps in that half, and with an additional delay determined by second delay circuit 48 a second one of first control registers 42b is set to restore current to the other one of the lamps in that half. First delay circuit 46 implements control of the supplied power. Second delay circuit 48 implements the offset used to reduce harmonics. When zero crossings detector 40 detects a zero crossing in the opposite direction the same occurs for the other half of the lamps.

The offset may be selected experimentally, by varying the offset until a value is found that leads to compliance with the maximum acceptable level of harmonics and by programming that value into the microcontroller or selecting a corresponding delay circuit. In principle the same offset may be used for all power levels, but alternatively the offset may be varied as a function of the power level, less offset sufficing as the current is switched back on closer to the zero crossing of the AC supply voltage.

Although an embodiment with four lamps has been shown it should be appreciated that a larger number of lamps may be used, preferably an even number. In this case the lamps are divided in two sets, to which current is switched off during respective time intervals in the positive and negative half cycles of the mains AC cycle respectively. If the harmonics level is still to low, the sets of lamps are divided into subsets of lamps. The current to lamps in each subset is switched on at a phase point corresponding to that subset, the phase point of different subsets being offset relative to one another. Two subsets may be used as in the example of FIG. 3, wherein each subset consists of one lamp, but a larger number of subsets may be used and/or each subset may contain more lamps.

For example, six lamps may be used, with three in the first set (switched off during a time interval in the positive half cycle) and three in the second set (switched off during a time interval in the positive half cycle). In this case current to each lamp in each subset may be switched on at a different phase point, or current to two lamps of a set may be switched on at one phase point and current to the third in the set at a different phase point. The selection can be made dependent on the desired level of harmonics. Similarly, in another embodiment eight lamps are used, with four in the first set (switched off during a time interval in the positive half cycle) and four in the second set (switched off during a time interval in the positive half cycle). In this case current to each lamp in each subset may be switched on at a different phase point, or current to two lamps of a set may be switched on at one phase point and current to the other of the set at a different phase point and so on.

Although an embodiment has been described wherein lamps are switched off at zero crossings and on at a phase point that is selected dependent on the desired power level, it should be understood that in an alternative embodiment a first half of the lamps may be switched off during each positive polarity half cycle at a phase point that is selected dependent on the desired power level and switched on at the next zero crossing. The second half of the lamps may be operated in the same way in each negative polarity half cycle. In this embodiment an offset may be used between the switch off of different lamps in said first half and between the switch off of different lamps in said second half.

It is preferred that one of the pair of on/off switching points for each lamp coincides with a zero crossing or nearly coincides (e.g. lies within one tenth of the AC cycle from the zero crossing). Alternatively any phase point may be selected, but this unnecessarily increases harmonics.

As will be appreciated the control range of the lamp system lies between half and full power, because all lamps will receive current during at least half a period of the AC cycle. If this range is too large additional lamps may be used that are not switched on and off by the control circuit.

While the invention has been illustrated and described in detail in the drawings and foregoing description, such illustration and description are to be considered illustrative or exemplary and not restrictive; the invention is not limited to the disclosed embodiments. Although an example has been give using a lamp system, it should be appreciated that the lamps may be replaced by other types of load, making the lamps system a power supply system. In one example the loads may be heating elements, the system reducing heating variations of a controlled heating power with frequencies below the AC frequency with a minimum of interference.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. A power supply system, comprising:
AC power supply terminals (10, 11) for receiving AC voltage in periodic AC cycles;
a plurality of loads (12);
switches (14) coupled between the power supply terminals (10, 11) in series with the loads (12);
a control circuit (16) coupled to control inputs of the switches (14) and configured to control energy supplied to the loads (12) by causing the switches (14) to switch current to loads of a first half of the plurality of loads (12) on or off at one or more selectable phase points (30a,b) during each positive half of the AC cycles and to switch current to loads of a second half of the plurality of the loads (12) half an AC cycle out of phase with corresponding loads in the first half of the loads (12).

2. A power supply system wherein the loads are lamps (12).

3. A power supply system according to claim 1, wherein the plurality of loads (12) comprises at least four loads (12), the selectable phase points comprising at least two phase points (230a,b) with a temporal offset with respect to each other, the control circuit being configured to switch respective subsets of the loads of the first half on or off at respective ones of the at least two phase points (30a,b).

4. A power supply system according to claim 1, wherein the control circuit (16) is configured to switch the current to the loads (12) of the first half of the plurality of loads off at the start of each positive half cycle and to switch the current to loads in respective ones of the subsets on at the respective ones of the phase points (30a,b) in each positive half cycle.

5. A power supply system according to claim 1, wherein the control circuit (16) is configured to switch the current to loads (12) in respective ones of the subsets off at the respective ones of the phase points (30a,b) in each positive half cycle and to switch the current to the loads of the first half of the plurality of loads on at the end of each positive half cycle.

6. A power supply system according to claim 3, wherein each subset consists of one load (12).

7. A method of controlling the light intensity of a plurality of lamps (12), the method comprising:
providing AC power supply voltage in periodic AC cycles;
switching current to lamps (12) of a first half of the plurality of lamps on or off at one or more selectable phase points during each positive half of the AC cycles;
switching current to lamps (12) of a second half of the plurality of lamps, half an AC cycle out of phase with corresponding lamps in the first half of the lamps (12).

8. A method according to claim 7, wherein the plurality of lamps (12) comprises at least four lamps (12), the selectable phase points comprising at least two phase points (30a,b) with a temporal offset with respect to each other, the method comprising switch respective subsets of the lamps of the first half on or off at respective ones of the at least two phase points (30a,b).

9. A method according to claim 8, comprising:
switching the current to the lamps (12) of the first half of the plurality of lamps (12) off at the start of each positive half cycle;
switching the current to lamps (12) in respective ones of the subsets on at the respective ones of the phase points (30a,b) in each positive half cycle.

10. A method according to claim 8, comprising:
switching the current to lamps (12) in respective ones of the subsets off at the respective ones of the phase points (30a,b) in each positive half cycle;
switching the current to the lamps (12) of the first half of the plurality of lamps on at the end of each positive half cycle.

11. A lamp system, comprising:
AC power supply terminals (10, 11) for receiving AC voltage in periodic AC cycles;
a plurality of lamps (12);
switches (14) coupled between the power supply terminals (10, 11) in series with the lamps (12);
a control circuit (16) coupled to control inputs of the switches (14) and configured to control light intensity of the lamps (12) by causing the switches (14) to switch current to lamps of a first half of the plurality of lamps (12) on or off at one or more selectable phase points (30a,b) during each positive half of the AC cycles and to switch current to lamps of a second half of the plurality of the lamps (12) half an AC cycle out of phase with corresponding lamps in the first half of the lamps (12).
